(19) United States
(12) Patent Application Publication
(10) Pub. No.: US 2009/0021582 A1
(43) Pub. Date: Jan. 22, 2009

(54) Vehicle and Driving Assist System for Vehicle

(75) Inventor: Akira Nakaya, Kakogawa-shi (JP)

Correspondence Address: ALLEMAN HALL MCCOY RUSSELL & TUTTLE LLP, 806 SW BROADWAY, SUITE 600, PORTLAND, OR, 97205-3335, US

(73) Assignee: KAWASAKI JUKOGYO KABUSHIKI KAISHA, Kobe-shi (JP)

(21) Appl. No.: 12/124,971

(22) Filed: May 21, 2008

(30) Foreign Application Priority Data
Jul. 20, 2007 (JP) 2007-189559

(51) Int. Cl. H04N 7/18

(52) U.S. Cl. 348/148; 348/E07.085

(57) ABSTRACT

A vehicle of the present invention comprises a side mirror assembly provided in a main body of the vehicle, and an imaging device configured to take an image of a scene near the vehicle, and the imaging device is disposed in an inner space of the side mirror assembly. A driving assist system for a vehicle of the present invention, comprises an imaging device configured to take an image of a scene near the vehicle, an image processing device configured to process an image obtained by the imaging device, and a notification device configured to notify information regarding an image processed by the image processing device, and the imaging device is disposed in an inner space of the side mirror assembly provided in a main body of the vehicle.

### TECHNICAL FIELD

The present invention relates to a vehicle comprising an imaging device and a driving assist system for the vehicle.

### BACKGROUND

Conventionally, a structure for mounting imaging devices to vehicles such as four-wheeled vehicles, motorcycles, or personal watercraft has been proposed.

Japanese Laid-Open Patent Application Publication No. 2006-103600 discloses a motorcycle comprising an imaging device at a front part of a vehicle body thereof. The imaging device is disposed in a space formed between an instrument panel and a windscreen. Members by which the imaging device is fastened are provided in the vicinity of the instrument panel or on the windscreen. The imaging device takes an image of a scene forward of a vehicle through the windscreen.

Japanese Utility Model Application Publication No. Hei. 2-125298 discloses an imaging device fastened by threaded members to an outer surface of a side mirror assembly of a motorcycle including a mirror and a bowl-shaped mirror holder. A driver can take an image of a scene near the motorcycle using the fastened imaging device, during driving.

According to the disclosure of Japanese Laid-Open Patent Application Publication No. 2006-103600, a space is required in the vicinity of the windscreen to dispose the imaging device. For this reason, a structure of a front part of a vehicle body may be complicated or a size of the front part of the vehicle body may increase.

According to the disclosure of Japanese Utility Model Application Publication No. Hei. 2-125298, since the imaging device is fastened to an outer surface of a side mirror assembly, the imaging device may be damaged if the side mirror assembly contacts an object near the side mirror assembly. In addition, since a blowing wind is directly applied to the imaging device, the imaging device is unstably fixed because of a wind pressure applied thereto, or air resistance of the entire vehicle body may increase.

Accordingly, an object of the present invention is to dispose an imaging device so that the imaging device is less likely to be affected by external factors, for example, the imaging device is less likely to be damaged due to contact or is less likely to be affected by a wind pressure.

### DESCRIPTION OF INVENTION

A vehicle of the present invention comprises a side mirror assembly provided in a main body of the vehicle; and an imaging device configured to take an image of a scene near the vehicle; wherein the imaging device is disposed in an inner space of the side mirror assembly.

In the above described configuration, the imaging device is disposed in the inner space of the side mirror assembly which is a conventionally dead space, rather than the main body of the vehicle. For this reason, a size of the main body of the vehicle does not increase or a structure of the main body does not become complicated by incorporating the imaging device into the vehicle. In addition, the imaging device does not affect air resistance of the entire vehicle and is less likely to be externally damaged.

The imaging device may be provided in an inner space of each of a pair of side mirror assemblies. Thereby, a stereo image can be obtained using the two imaging devices. In addition, since the two imaging devices are provided separately in the pair of side mirror assemblies, a stereo base is increased.

The vehicle may be a straddle-type vehicle, and the imaging devices may be each configured to take an image of a scene forward of the straddle-type vehicle. Thereby, even in the straddle-type vehicle having a smaller width dimension, the imaging devices can be disposed at outermost sides in a rightward and leftward direction. The straddle-type vehicle may be a motorcycle. Since the two imaging devices are disposed in locations which are most distant possible in the rightward and leftward direction in the straddle-type vehicle having a smaller width dimension, the stereo image can be created precisely using the two imaging devices.

At least a part of the imaging device may be disposed in the inner space to be located closer to a center of a main body of the vehicle. The side mirror assembly tends to vibrate due to an influence of vibration generated at the main body of the vehicle or vibration applied from a road surface. If the side mirror assembly is positioned more distant from the main body of the vehicle, then it is more likely to be affected by the vibration and tends to vibrate more highly. In the above configuration, since the imaging device is disposed in the location where the imaging device is relatively less affected by the vibration, an image which is less blurry can be created. Even when the side mirror assembly makes contact with an object near the vehicle during driving, the imaging device is less likely to be damaged.

The side mirror assembly may have a dimension which is smaller in a region which is more distant from the main body of the vehicle in the rightward and leftward direction, as viewed from front and from above. Thereby, in the side mirror assembly, a pressure-receiving area to which blowing wind is applied is smaller and air resistance during driving is lower in a region which is more distant from the main body of the vehicle in the rightward and leftward direction. In contrast, the volume of the inner space of the side mirror assembly increases toward the center of the main body of the vehicle. The imaging device is disposed in such a region of the inner space which is closer to the center of the main body. Thus, a space for disposing the imaging device can be sufficiently provided.

The side mirror assembly may include a camera cover portion which is made of a light transmissible material and covers a front side of the imaging device.

This makes it possible to take an image of the scene forward of the vehicle through the camera cover portion, and to protect the imaging device from mud or small stones.

The side mirror assembly may have a front edge extending lower than a vertical center of the side mirror assembly. At least a part of the imaging device may be disposed in a region of the inner space which is above the front edge of the side mirror assembly. In accordance with this, since the front edge of the side mirror assembly is located lower than the vertical center of the side mirror assembly, a large part of the blowing wind applied to the side mirror assembly flows rearward along a surface of the region of the side mirror assembly which is above the front edge and thus a force is applied on the side mirror assembly to press it downward. In addition, the inner space of the side mirror assembly provides a larger space in the region above the front edge. The imaging device is disposed in such a region. Thus, a space for disposing the imaging device can be sufficiently provided.

The side mirror assembly may be fastened to a cowling of the motorcycle. The side mirror assembly may be rotatable integrally with a steering member of the vehicle.

The imaging device may be configured to take an image of a scene forward of the vehicle.

A driving assist system for a vehicle, of the present invention comprises an imaging device configured to take an image of a scene near the vehicle; an image processing device configured to process an image obtained by the imaging device; and a notification device configured to notify information regarding the image processed by the image processing device; wherein the imaging device is disposed in an inner space of each of a pair of side mirror assemblies provided in a main body of the vehicle.

In the above configuration, during driving, the driver is able to check around the vehicle with reference to the image displayed based on the image obtained by the imaging device. The imaging device is disposed in the inner space of the side mirror assembly which is conventionally the dead space, rather than on the main body of the vehicle. Therefore, the driving assist system for the vehicle can be configured without increasing the size of the main body of the vehicle or making its structure complicated, or by increasing air resistance of the entire vehicle. Furthermore, the imaging device forming the driving assist system for the vehicle including the imaging device is less likely to be externally damaged.

The above and further objects and features of the invention will more fully be apparent from the following detailed description with accompanying drawings.

### BRIEF DESCRIPTION OF THE DRAWINGS

FIG. 1 is a left side view of a motorcycle, which is one example of a vehicle according to the present invention;

FIG. 2 is a plan view of the motorcycle;

FIG. 3 is a front view of the motorcycle;

FIG. 4 is a left side view of a front part of a vehicle body of the motorcycle;

FIG. 5 is a plan view of a left side mirror assembly of the motorcycle;

FIG. 6 is a side view of the left side mirror assembly of the motorcycle;

FIG. 7 is a front view of the left side mirror assembly of the motorcycle;

FIG. 8 is a view taken in the direction of arrows VIII-VIII in FIG. 5, showing a region in a center section in a rightward and leftward direction in an inner space of the left side mirror assembly;

FIG. 9 is a view taken in the direction of arrows IX-IX in FIG. 5, showing a space region in the inner space of the left side mirror assembly, which is closer to a center of the vehicle body;

FIG. 10 is a block diagram showing a configuration of a night vision system of the motorcycle, which is one example of a driving assist system for a vehicle according to the present invention; and

FIG. 11 is a flowchart showing a process performed by an electronic control unit of the night vision system.

### DETAILED DESCRIPTION

Hereinafter, an embodiment of the present invention will be described with reference to the accompanying drawings. In description herein below, a motorcycle is illustrated as a preferred embodiment of the vehicle according to the present invention. Herein, directions are generally referenced from the perspective of a driver (not shown) mounting the motorcycle.

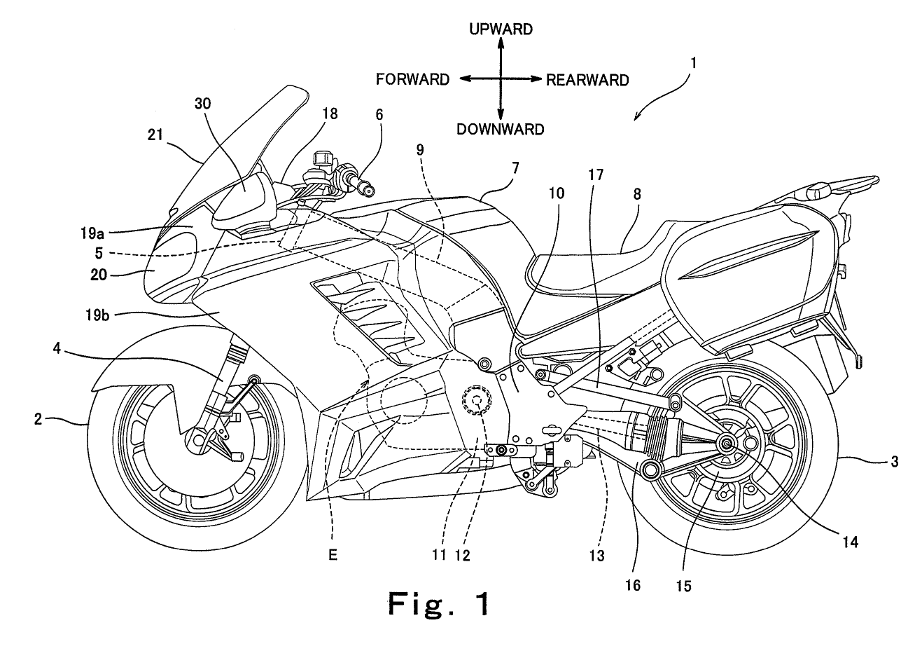

As shown in FIG. 1, a motorcycle 1 includes a front wheel 2 and a rear wheel 3. The front wheel 2 is rotatably mounted to a lower end portion of a front fork 4 extending substantially vertically. The front fork 4 is mounted on a steering shaft (not shown) by an upper bracket (not shown) attached to an upper end portion thereof, and an under bracket (not shown) located below the upper bracket. The steering shaft is rotatably supported by a head pipe 5. A bar-type steering handle 6 extending rightward and leftward is attached to the upper bracket. When the rider rotates the steering handle 6, the front wheel 2 is turned to a desired direction around the steering shaft. A fuel tank 7 is disposed behind the steering handle 6. A straddle-type seat 8 is provided behind the fuel tank 7.

Main frames 9 extend rearward from the head pipe 5 to be tilted slightly in a downward direction. Pivot frames 10 are respectively coupled to rear portions of the main frames 9. An engine E is mounted between the front wheel 2 and the rear wheel 3 in such a manner that the engine E is mounted on the main frames 9, the pivot frames 10, and other members. A transmission 11 is provided integrally with the engine E. A front end portion of a drive shaft 13 is coupled to an output shaft 12 of the transmission 11 via a bevel gear. A rear end portion of the drive shaft 13 is coupled to a rear gear case 15 coupled to an axle 14 of the rear wheel 3. A swing arm 16 and a torque rod 17 are provided in parallel in upper and lower positions between the pivot frame 10 and the gear case 15.

A meter device 18 for displaying a vehicle speed, an engine speed, etc. is attached in front of the steering handle 6. A front cowling 19a and side cowlings 19b are provided to extend from a front portion to side portions so as to cover the engine E and other components.

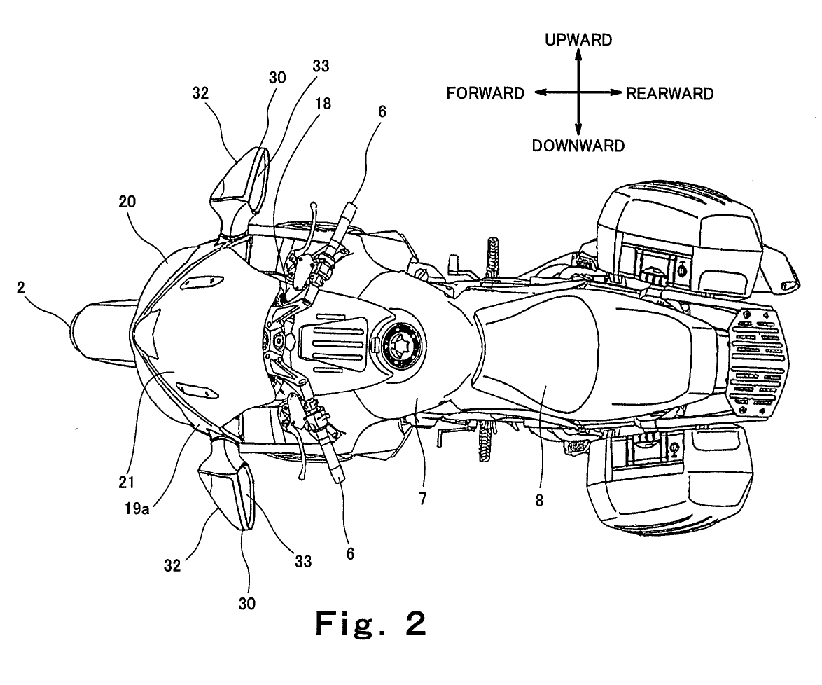

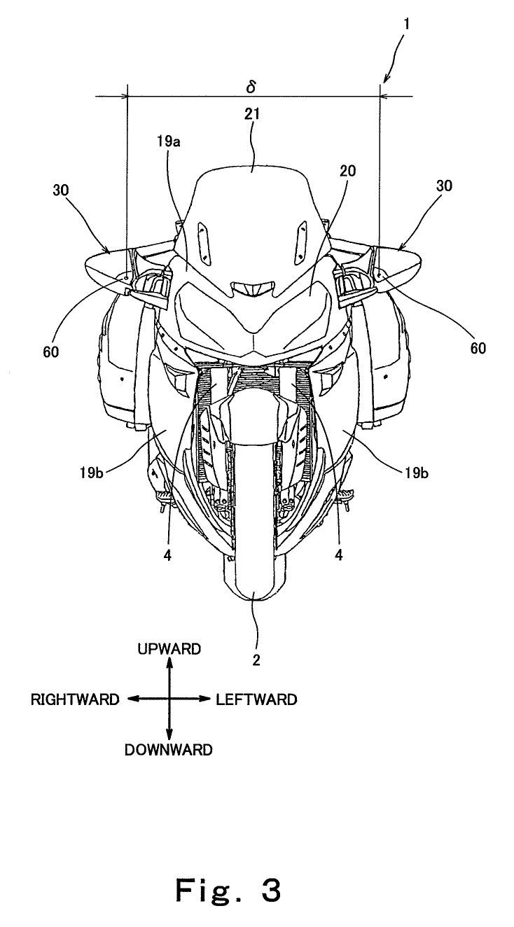

As shown in FIGS. 1 to 3, a head light assembly 20 is provided at the front part of the vehicle body (main body of the vehicle) continuously with the front cowling 19a. A windscreen 21 formed of a transparent resin plate is disposed at an upper portion of the headlight assembly 20 to protect the driver from blowing wind. On right and left sides of the front part of the vehicle body, side mirror assemblies 30 are mounted to protrude from the front cowling 19a. In FIG. 3, 6 indicates a stereo base of a far-infrared camera 60 to be described later.

Here it is assumed that the vehicle body includes frame members such as the main frames 9, the pivot frames 10, the swing arms 16, the head pipe 5, and the front fork 4, forming a frame of the motorcycle 1, and members covering the frame members (e.g., cowling members including the front cowling 19a and the side cowlings 19b, the seat 7, the fuel tank 8, and the head light assemblies 20).

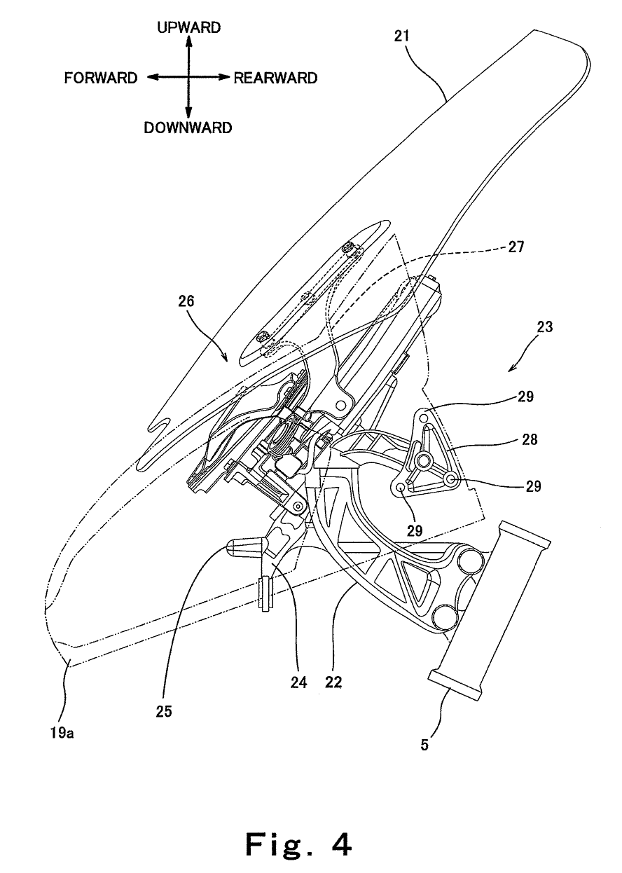

In FIG. 4, the side cowling and the side mirror assembly are not illustrated, the front cowling 19a is indicated by two-dotted line, and its internal structure is indicated by solid line. As shown in FIG. 4, the head pipe 5 is provided with a center bracket 22 extending to be tilted upward in a forward direction, and a cowling stay 23 extending rightward and leftward is attached to a front end of the center bracket 22. The center bracket 22 has an extended portion 24 extending downward. The extended portion 24 is provided with a protrusion 25 protruding forward. The headlight assembly 20 is fittingly coupled to the protrusion 25. A screen up-down device 26 is provided on an upper surface of the cowling stay 24. The screen up-down device 26 enables a windscreen 21 fastened to a screen mounting portion 27 to move up and down. The cowling stay 24 is further provided with mirror mounting portions 28 at right and left end portions, respectively. The front cowling 19a and side mirror assemblies 30 (FIGS. 1 through 3) are coupled to the right and left mirror mounting portions 28.

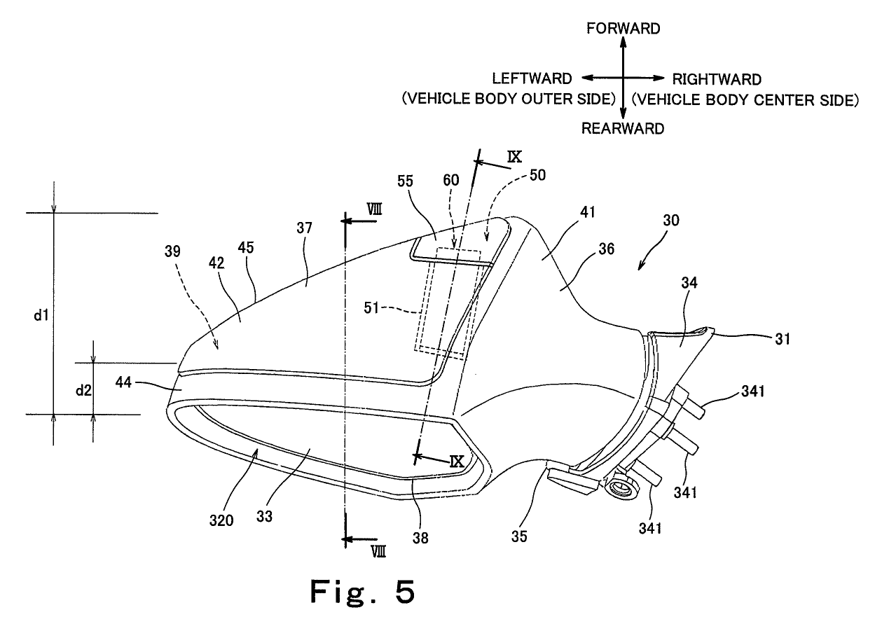

In FIGS. 5 to 7, the side mirror assembly 30 coupled to the left mirror mounting portion 28 (FIG. 4) is shown. The side mirror assembly coupled to the right mirror mounting portion is laterally symmetric with respect to the left side mirror assembly 30, and will not be further described. As shown in FIGS. 5 to 7, the side mirror assembly 30 includes a support base 31 fastened to the mirror mounting portion 28 (see FIG. 4), a bowl-shaped mirror holder 32 mounted to the support base 31, and a mirror 33 provided to cover an opening 320 of the mirror holder 32.

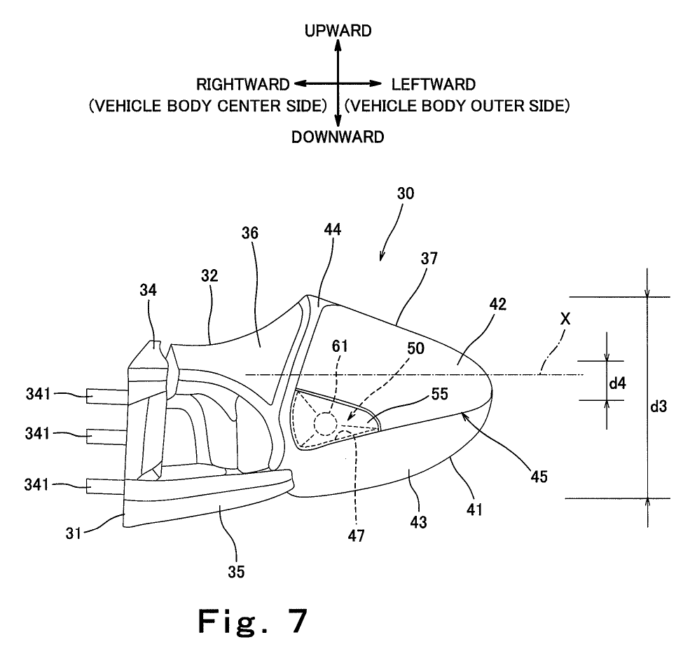

As shown in FIG. 7, the support base 31 is substantially L-shaped, including a vertical wall portion 34 extending vertically, and a stay portion 35 extending horizontally from a lower end of the vertical portion 34. The vertical portion 34 is provided with a plurality of protrusions 341 protruding from a side surface thereof which is closer to the center of the vehicle body. The protrusions 341 are fitted to boss holes 29 (FIG. 4) formed in the mirror mounting portion 28 so that the support base 31 is positioned and fastened with respect to the mirror mounting portion 28.

As shown in FIGS. 5 to 7, the mirror holder 32 includes an arm portion 36 supported on the stay portion 35 of the support base 31 and a bowl-shaped receiver portion 37 connected to the arm portion 36. A cylindrical support shaft portion (not shown) protruding upward is provided on an upper surface of the stay portion 35. A cylindrical boss hole (not shown) is formed in the interior of the arm portion 36 to open in a lower surface of the arm portion 36. The boss hole is fitted to the support shaft portion of the stay portion 35 so that the mirror holder 32 is pivotally mounted to the support base 31.

The mirror 33 is supported by a mirror support frame 38 pivotally provided in the interior of the receiver portion 37.

In the side mirror assembly 30, the mirror holder 32 is pivotable between a protruding position in which the mirror holder 32 protrudes rightward or leftward and the mirror 33 faces backward, and a stowed position in which the mirror holder 32 is folded toward the vehicle body and the mirror 33 faces the center of the vehicle body. The driver mounting the seat 8 is able to see rear and sides of the vehicle by the mirrors 33 by placing the mirror holders 32 in the protruding position as shown in FIGS. 5 to 7. In addition, the driver is able to change mounting angles of the mirrors 33 according to a physical constitution of the driver by pivoting the mirrors 33 together with the mirror support frames 38.

The receiver portion 37 includes a holder base 41 and a holder cover 42 covering the holder base 41. The holder base 41 includes a lower wall portion 43 forming a lower wall of the receiver portion 37 and a frame portion 44 forming a frame defining the opening 320 of the receiver portion 37 covered with the mirror 33. The holder cover 42 is attached to the holder base 41 from above and forms an upper wall of the receiver portion 37.

An inner space 39 which is defined by the receiver portion 37 (i.e., the holder base 41 and the holder cover 42) and the mirror 33 is formed in the side mirror assembly 30. The holder base 41 and the holder cover 42 are manufactured by injection molding using synthetic resin or the like and each has a substantially even thickness. Therefore, the inner space 39 substantially conforms in shape to the outer shape of the receiver portion 37 shown in FIGS. 5 to 7.

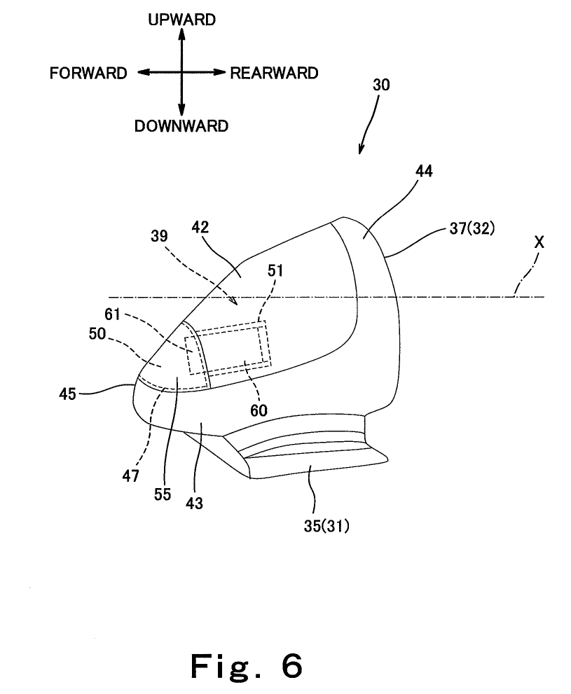

The receiver portion 37 is formed to have a dimension in a forward and rearward direction which is smaller in a region which is more distant from the vehicle body, as can be seen from a plan view of FIG. 5 in which d1 indicates the dimension in the forward and rearward direction of the end portion of the receiver portion 37 which is closer to the center of the vehicle body and d2 indicates the dimension in the forward and rearward direction of the end portion of the receiver portion 37 which is on outer side of the vehicle body. Also, the receiver portion 37 is formed to have a vertical dimension which is smaller in a region which is more distant from the vehicle body, and its protruding end portion has a dimension decreasing toward a tip end, as can be seen from a front view of FIG. 7 in which d3 indicates the vertical dimension of the end portion of the receiver portion 37 which is closer to the center of the vehicle body and d4 indicates the vertical dimension of the end portion of the receiver portion 37 which is on outer side of the vehicle body. Thereby, a pressure-receiving area to which the blowing wind is applied can be reduced so that air resistance of the side mirror assembly 30 is lessened. As shown in FIGS. 6 and 7, a front edge 45 of the receiver portion 37 is formed by a portion where a front upper edge of the lower wall portion 43 of the holder base 41 and a lower edge of the holder cover 42, and extends to be lower than a center line in the vertical direction of the entire receiver portion 37, which is indicated by one-dotted line X. Thereby, a large part of the blowing wind applied to the side mirror assembly 30 flows rearward along a surface of an upper side of the receiver portion 37, and thus a force is applied on the side mirror assembly 30 to press it downward toward a road surface.

As should be appreciated from the above, the receiver portion 37 has an outer shape allowing for air force. Thereby, a volume of the inner space 39 of the side mirror assembly 30 increases toward the center of the vehicle body and in a region above the front edge 45.

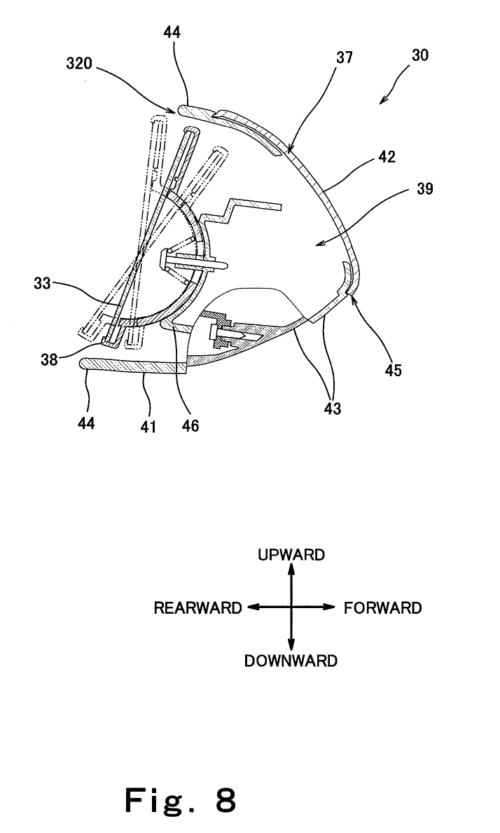

As shown in FIG. 8, a support member 46 for supporting the above described mirror support frame 38 is accommodated in this space region of the inner space 39. The support member 46 is fastened to the lower wall portion 43 of the holder base 41 by threaded members or the like. The mirror support frame 38 is in spherical-surface contact with the support member 46 and is supported to be pivotable upward and downward and rightward and leftward along the spherical surface. By positioning the support member 46 in the space region of the center section in the rightward and leftward direction in the inner space 39, a contact portion with the mirror support frame 38 is set in a substantially center position of the opening 320 of the receiver portion 37 so that the mirror 33 and the mirror support frame 38 are pivotable evenly upward and downward and rightward and leftward.

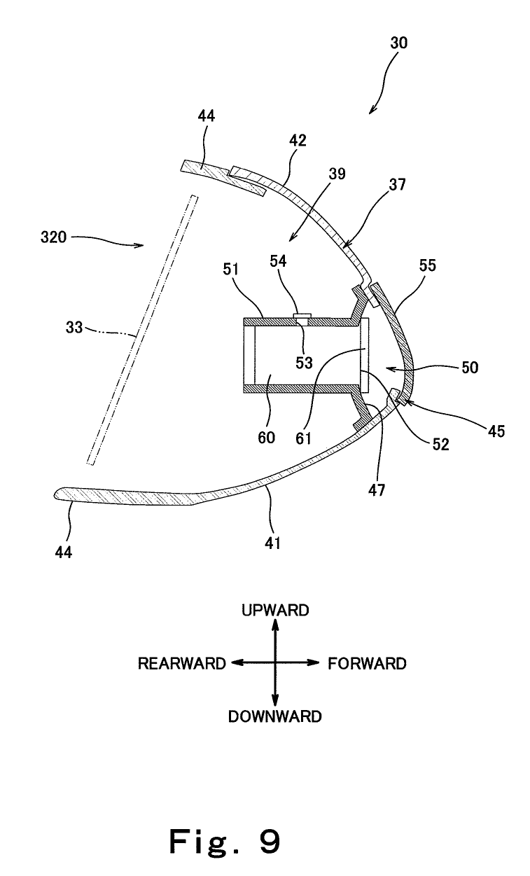

As shown in FIGS. 5 to 7 and 9, a cone-shaped (in the present embodiment, triangular-pyramid shaped as shown in FIG. 7) attachment 47 is provided at an end portion of the front upper edge of the lower wall portion 43 of the holder base 41 which is closer to the center of the vehicle body. The holder cover 42 is formed such that an end portion of a lower edge thereof which is closer to the center of the vehicle body is cut out to conform to the upper edge of the attachment 47. The attachment 47 forms a concave portion 50 recessed rearward at the end portion of a front part of the receiver portion 37 which is closer to the center of the vehicle body. The attachment 47 defining the concave portion 50 is provided integrally with a cylindrical camera accommodating portion 51 protruding rearward from a back surface thereof. A far-infrared camera 60 having a substantially cylindrical casing is accommodated in the camera accommodating portion 51. The far-infrared camera 60 is an imaging device which measures a temperature of a surface of an object and displays a temperature distribution thereof as a monochrome image or a colored image in two-dimensional form.

Thus, the concave portion 50 is formed in the receiver portion 37 to be located closer to the center of the vehicle body, and the attachment 47 defining the concave portion 50 is positioned above the front edge 45 of the receiver portion 37. The camera accommodating portion 51 provided integrally with the attachment 47 is positioned in the space region of the inner space 39 of the side mirror assembly 30 which is closer to the center of the vehicle body and is above the front edge 45.

When assembling the far-infrared camera 60, the far-infrared camera 60 is inserted into the interior of the camera accommodating portion 51 prior to attaching the holder cover 42 to the holder base 41. A threaded hole 53 is formed in the camera accommodating portion 51 to radially penetrate therethrough. A threaded member 54 is inserted into the threaded hole 53 so that the far-infrared camera 60 is fastened in the interior of the camera accommodating portion 51. In this case, an objective lens 61 of the far-infrared camera 60 is exposed forward within the concave portion 50. In the state where the holder cover 42 is not attached, the threaded hole 53 is easily accessible, since the above described inner space 39 opens upward. Since the receiver portion 37 is constructed of two members, i.e., the holder base 41 and the holder cover 42 in the manner described above, an operation for fastening the far-infrared camera 60 can be carried out easily.

In the state where the far-infrared camera 60 is fastened, the holder cover 42 is attached to the holder base 41 to close the inner space 39. In addition, the camera cover 55 which is made of a light-transmissible material such as acrylic is attached to cover the concave portion 50. The camera cover 55 has an outer surface to form a curved surface smoothly continuous with the outer surface of the holder cover 42 in the assembled state so that air resistance of the side mirror assembly 30 is not increased.

In the state where the side mirror assembly 30 containing the far-infrared camera 60 is mounted to the vehicle body, an image of the scene forward of the vehicle can be taken through the camera cover 55 during driving. In this case, even if foreign matters such as mud or small stones are scattered toward the side mirror assembly 30, the camera cover 55 protects the objective lens 61 of the far-infrared camera 60 from these foreign matters.

As should be appreciated from the above, in the present embodiment, the far-infrared camera 60 is disposed in a dead space formed in the assembly in which the mirror 33 is provided in the bowl-shaped receiver portion 37. This makes it possible to avoid that the structure of the vehicle body becomes complicated or the vehicle body becomes large-sized. In addition, the inner space 39 has a volume which is larger in the region closer to the center of the vehicle body and in the upper space region, in view of the air force. The far-infrared camera 60 is disposed in the space which has such a larger volume. Since the support member 46 for supporting the mirror support frame 38 is disposed in the space region in the center section in the rightward and leftward direction of the inner space 39 to correctly set a pivot of the mirror 33, the camera accommodating portion 51 is disposed not to interfere with the support member 46.

In particular, in the side mirror assembly 30, the space region which is closer to the vehicle body is relatively less affected by vibration generated at the vehicle body or applied from the ground surface. By disposing the far-infrared camera 60 in such a space region, an image which is less blurry can be obtained. Whereas the protruding end portion of the side mirror assembly 30 is likely to contact objects near the side mirror assembly 30 during driving, the far-infrared camera 60 is less likely to be damaged, since the far-infrared camera 60 is disposed in the space region which is closer to the center of the vehicle body. Furthermore, since the side mirror assembly 30 is fastened to the cowling, it does not vibrate so high as the side mirror assembly 30 fastened to the steering.

In a case where the side mirror assembly is rotatable integrally with the steering, the far-infrared camera mounted within the side mirror assembly rotates according to the steering and the front wheel in a direction according to the driver's operation, and its optical axis is oriented in a driving direction of the vehicle. Therefore, even while the vehicle is driving at a corner, the image of the scene forward of the vehicle can be taken.

While the far-infrared camera 60 is illustrated as the imaging device, the configuration of the imaging device can be changed suitably according to uses. For example, a camera capable of taking a visible image may be used.

The imaging device may be provided in one of or both of the pair of right and left side mirror assemblies 30. When the imaging devices are provided in both of the right and left assemblies 30, a stereo image can be created as described later. Since far-infrared cameras 60 are provided in the side mirror assemblies 30 protruding from the vehicle body, a distance between the far-infrared cameras 60 can be made larger. Since the stereo base 8 (see FIG. 3) is made larger in this way, calculation precision of depth information (distance information in the forward and rearward direction) of an object which is far away from the vehicle can be increased.

As should be appreciated, the far-infrared camera is a device which is capable of measuring a distance from the vehicle body to an object or the like forward of the vehicle, i.e., in substantially the direction in which the optical axis is oriented, as well as of obtaining the image. The imaging device of the present invention is meant to include the devices having such a capability, and include distance measuring sensors such as a millimeter wave radar or an ultrasonic wave sensor, in addition to the far-infrared camera. When the distance measuring sensor is provided instead of the far-infrared camera, the same advantages can be achieved.

The vehicle of the present invention is suitably applicable to the straddle-type vehicle. The straddle-type vehicle is operated by the driver straddling a driver's seat. The straddle-type vehicles include, for example, at least motorcycles or all terrain vehicles such as four-wheeled buggies, and personal watercraft. Most of the straddle-type vehicles have a width dimension smaller than that of an automobile. In particular, the motorcycle has a smaller width dimension. By disposing the imaging devices at locations which are most distant possible in the width direction in the vehicle having such a smaller width dimension, calculation precision of the distance from the vehicle to the object can be increased.

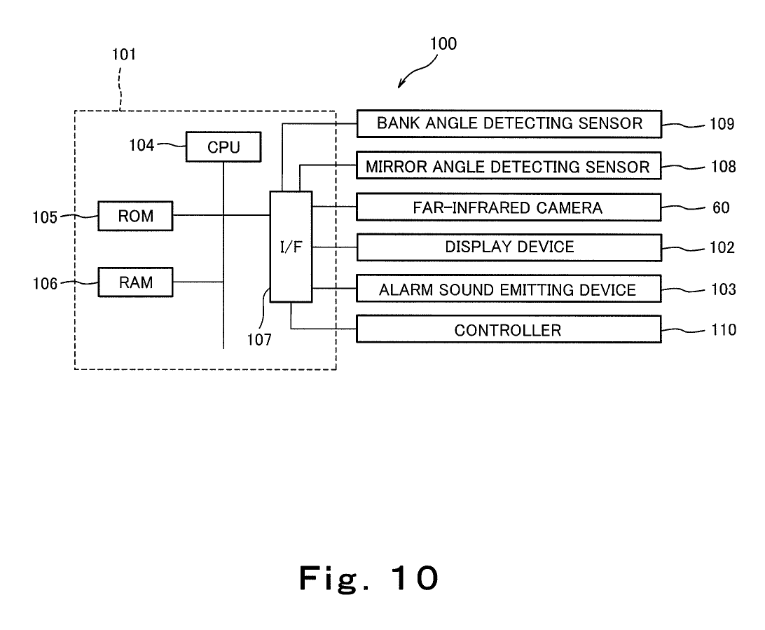

Hereinafter, an embodiment in which the driving assist system for the vehicle of the present invention is applied to a night vision system of the motorcycle. FIG. 10 is a block diagram showing a configuration of a night vision system 100 of the motorcycle 1. As shown in FIG. 10, the night vision system 100 of the motorcycle 1 includes a far-infrared camera 60 configured to take an image of a scene forward of the vehicle, an electronic control unit (ECU) 101 configured to process the image taken by the far-infrared camera 60, and a display device 102 and an alarm sound emitting device 103 which are notification devices controlled by the ECU 101.

The ECU 101 includes as a major component a microcomputer comprised of a CPU 104, a ROM 105, a RAM 106, and an input/output interface (I/F) 107. The CPU 104 runs a computer program stored in the ROM 105, so that the ECU 101 operates as described later. Data generated or obtained by the operation is stored in the RAM 106 to be temporarily held therein. Specified data such as head part characteristic amount data and body characteristic amount data to be described later are pre-stored in the ROM 105.

The ECU 101 is coupled to the far-infrared camera 60, the display device 102, and the alarm sound emitting device 103 via the I/F 107.

The far-infrared cameras 60 are built into the pair of right and left side mirror assemblies 30 of the motorcycle 1, respectively as described above. Optical axes of the two far-infrared cameras 60 extend substantially in parallel in the forward and rearward direction. The far-infrared cameras 60 repeat imaging processing at specified time intervals according to a command output from the ECU 101 via the I/F 107, and output the resulting images to the ECU 101 via the I/F 107. The ECU 101 is configured to be able to obtain depth information (actual distance in the forward and rearward direction from the vehicle to an object) of the object on the images based on the images taken by the two imaging devices.

To be specific, in a case where the respective far-infrared cameras 60 take an image of one object, the object is located nearer the motorcycle 1 when an azimuth difference between a coordinate position of the object on one image and a position of the object on the other image is larger.

The ECU 101 is configured to be able to, utilizing this fact, calculate depth information of the object. To be specific, the ROM 105 contains numeric information indicating the stereo base 5 and a stereo image processing program for obtaining depth information. The RAM 106 stores information indicating the image sequentially transmitted from each far-infrared camera 60. When the stereo image processing program is run, the ECU 101 executes the image processing to select the object displayed on both of the two images taken simultaneously and stored in the RAM 106. Subsequently, the ECU 101 extracts characteristic points from the two images and finds the azimuth difference. Then, the ECU 101 assigns a numeric value indicating the azimuth difference relating to the image and the stereo base 8 to a formula using a principle of triangular surveying, thereby calculating a distance from the motorcycle 1 to the object.

The display device 102 is a color display used to notify a driver of the motorcycle of information regarding detection of a person. The alarm sound emitting device 103 is a device configured to emit a sound alarm emitted to alert the driver, when the person is detected. The alarm sound emitting device 103 executes an emitting process of the alarm sound according to a command output from the ECU 101 via the I/F 107. The display device 102 and the alarm sound emitting device 103 are provided in the vicinity of, for example, the meter device 18 in the vehicle body of the motorcycle 1 so that the driver mounting the seat 8 easily recognize the operation of these devices 102 and 103.

The display device 102 may be constructed of a helmet mount display. In this case, the night vision system 100 is equipped with a short-distance radio device according to a specification, for example Bluetooth (registered mark) to receive and send information between the CPU 104 on the vehicle body side and the display device on the helmet side. Likewise, the alarm sound emitting device 103 may be provided on the helmet side. By providing the display device 102 and the alarm sound emitting device 103 on the helmet side, a size of the front part of the vehicle body does not increase or a structure of the front part of the vehicle body does not become complicated.

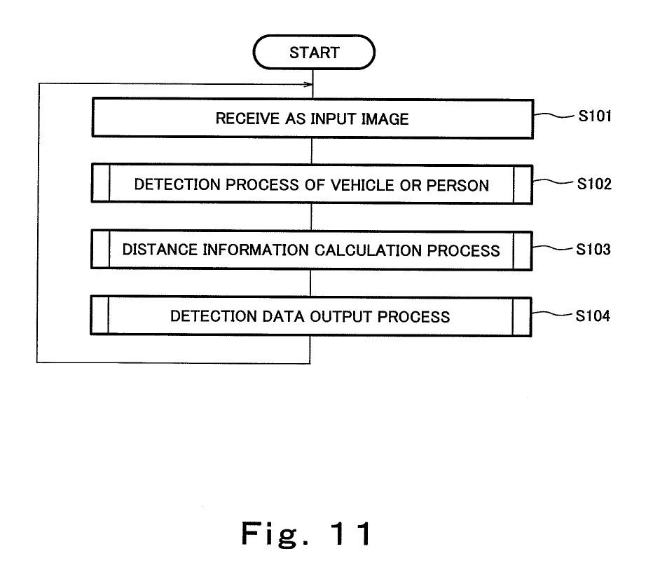

FIG. 11 is a flowchart showing a flow of an operation of the night vision system 100. The operation of the night vision system 100 illustrated here is controlled by the ECU 101. The operation described below is repeated at suitable timings during driving of the motorcycle 1.

First, the night vision system 100 receives as an input the image obtained by the far-infrared camera 60 (step S101). Data of the input image is stored in the RAM 106. Then, the ECU 101 executes a person detecting process for detecting a predetermined person pattern for determining a person, based on the image (step S102). When the person determination pattern is detected, this is extracted as a person area, and is set as an object in the stereo image processing.

Upon obtaining the image in the stereo image processing, the ECU 101 executes a distance information calculation process for calculating distance information from the vehicle to the person by the above described stereo image processing (step S103).

Then, the ECU 101 executes a detection data output process for notifying the driver of a detection data of the person based on the distance information (step S104). Here, the ECU 101 determines what range the distance between the person and the vehicle belongs to, among a close range (e.g., 0 to 100 m), an intermediate range (e.g., 100 to 200 m), and a distant range (200 m or more), selects drawing lines whose color is set according to the range to which the distance belongs (e.g., close range: red, intermediate range: orange, distant range: green, etc.), and causes the display device 102 to display a person frame by drawing the person area using the drawing lines of selected color. In addition, when the distance is in the close range, the ECU 101 causes the alarm sound emitting device 103 to emit alarm information. Thus, a series of process is terminated.

In the manner described above, the ECU 101 processes the images obtained by the two imaging devices to calculate a distance of the object. The display device 102 and the alarm sound emitting device 103 serve as the notification devices for notifying the distance of the object which has been calculated by the ECU 101. This enables the driver to easily recognize the distance to the person even during night.

In accordance with the night vision system of the present embodiment, since the far-infrared cameras 60 are provided in the pair of side mirrors, the stereo base δ can be made larger, and thus calculation precision of depth information of the object which is located more distant from the vehicle is improved. As described above, since the far-infrared cameras 60 are built into the side mirror assemblies 30, the night vision system can be configured without increasing the size of the structure of the front part of the vehicle body or by making the structure of the front part complicated. In addition, the night vision system can be configured without increasing air resistance of the vehicle because of the presence of the far-infrared cameras 60.

Since the far-infrared cameras 60 are disposed in locations where the cameras 60 are less affected by external damage, durability of the night vision system is improved.

Also, since the far-infrared cameras 60 are disposed in locations where the cameras 60 are less affected by vibration, the image which is less blurry can be obtained. Thus, detection precision of the person and calculation precision of the depth information are improved.

Whereas in the present embodiment, the far-infrared cameras 60 are built into both of the right and left side mirror assemblies 30, the depth information of the object on the image is calculated by the stereo image processing, and a drawing method of the person frame displayed on the display device is changed according to the distance from the vehicle to the person, one far-infrared camera may be built into one of the right and left side mirror assemblies 30, and the person frame may be displayed based on the image taken by the one far-infrared camera.

The driving assist system of the present invention is operable in a time period other than nighttime. Whereas in the above described embodiment, the range of the distance to the object in the forward and rearward direction is divided into three ranges, and the display configuration is according to the range to which the distance belongs, this configuration is merely exemplary. For example, when the ECU 101 determines that the object has reached a predetermined close range with respect to the motorcycle based on the calculation data resulting from the stereo image processing, the notification device such as the display device 102 or the alarm sound emitting device 103 may notify the driver that the object has reached the predetermined close range. This also serves to alert the driver. The object may be a vehicle located forward, fixed objects such as a power pole or a building, as well as the person. In this case, the process in step S102 in FIG. 11 is suitably changed into a vehicle detection process, for example. Alternatively, when the ECU 101 determines that the object has reached the predetermined close range, it may output a command to a controller 110, which executes control of a brake, an engine ignition timing, a fuel injection amount, a throttle opening degree, etc., to control a driving power output of the vehicle, decreasing a vehicle speed.

The ECU 101 may be configured to receive as an input a signal from a mirror angle detecting sensor 108 for detecting a change in a mounting angle of the mirror 33 via the I/F 107. The ECU 101 may be configured to correct the two images according to this detection signal after step S101.

The ECU 101 may be configured to receive as an input a signal from a bank angle sensor 109 for detecting a tilting angle of the vehicle via the I/F 107. The bank angle sensor 109 may be desirably configured to detect a roll angle, or may be configured to detect a pitch angle. The ECU 101 may be configured to correct the two images according to the detection signal after step S101.

The present invention is applicable to vehicles such as four-wheeled vehicles or personal watercraft, as well as to the motorcycle, so long as the vehicle is equipped with the side mirror assembly having an inner space.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A vehicle comprising:
a side mirror assembly provided in a main body of the vehicle; and
an imaging device configured to take an image of a scene near the vehicle;
wherein the imaging device is disposed in an inner space of the side mirror assembly.

2. The vehicle according to claim 1,
wherein the imaging device is provided in an inner space of each of a pair of side mirror assemblies.

3. The vehicle according to claim 2,
wherein the vehicle is a straddle-type vehicle, and the imaging devices are each configured to take an image of a scene forward of the straddle-type vehicle.

4. The vehicle according to claim 1,
wherein at least a part of the imaging device is disposed in the inner space to be located closer to a center of a main body of the vehicle.

5. The vehicle according to claim 4,
wherein the side mirror assembly has a dimension which is smaller in a region more distant from the main body of the vehicle in a rightward and leftward direction, as viewed from front and from above.

6. The vehicle according to claim 1,
wherein the side mirror assembly includes a camera cover portion which is made of a light transmissible material and covers a front side of the imaging device.

7. The vehicle according to claim 1,
wherein the side mirror assembly has a front edge extending lower than a vertical center of the side mirror assembly;
and wherein at least a part of the imaging device is disposed in a region of the inner space which is above the front edge of the side mirror assembly.

8. The vehicle according to claim 1,
wherein the vehicle is a straddle-type vehicle.

9. The vehicle according to claim 8,
wherein the straddle-type vehicle is a motorcycle.

10. The vehicle according to claim 9,
wherein the side mirror assembly is fastened to a cowling of the motorcycle.

11. The vehicle according to claim 1,
wherein the side mirror assembly is rotatable integrally with a steering member of the vehicle.

12. The vehicle according to claim 1,
wherein the imaging device is configured to take an image of a scene forward of the vehicle.

13. A driving assist system for a vehicle, comprising:
an imaging device configured to take an image of a scene near the vehicle;
an image processing device configured to process an image obtained by the imaging device; and
a notification device configured to notify information regarding an image processed by the image processing device;
wherein the imaging device is disposed in an inner space of a side mirror assembly provided in a main body of the vehicle.

14. The driving assist system for a vehicle, according to claim 13,
wherein the image processing device is configured to calculate a distance to an object forward of the vehicle based on two images obtained by two imaging devices.

15. The driving assist system for a vehicle, according to claim 13,
wherein the image processing device is configured to send image data or distance detection data to a controller of the vehicle to cause the controller to change a driving state.

16. The driving assist system for a vehicle, according to claim 15,
wherein the controller of the vehicle is configured to notify a driver that a distance between an object and the vehicle is smaller than a predetermined value, when the distance between the object and the vehicle is smaller than the predetermined value.

17. The driving assist system for a vehicle, according to claim 15,
wherein the controller of the vehicle is configured to decrease a vehicle speed of the vehicle when a distance between an object and the vehicle is smaller than a predetermined value.

18. The driving assist system for a vehicle, according to claim 13, further comprising:
an output sensor configured to output a signal indicating that a mirror angle has been changed;
wherein the image processing device is configured to correct two images according to the signal output from the output sensor.

19. The driving assist system for a vehicle, according to claim 13, further comprising:
a sensor configured to detect a roll angle of the vehicle;
wherein the image processing device is configured to correct an image based on the roll angle output from the sensor.
